(19) United States
(12) Patent Application Publication
(10) Pub. No.: US 2009/0047080 A1
(43) Pub. Date: Feb. 19, 2009

(54) Deep Hole Drill

(76) Inventors: Gunter Schweighofer, Budingen (DE); Peter Muller, Bad Homburg (DE)

Correspondence Address: DRINKER BIDDLE & REATH (DC), 1500 K STREET, N.W., SUITE 1100, WASHINGTON, DC, 20005-1209, US

(21) Appl. No.: 11/883,917

(22) PCT Filed: Feb. 8, 2006
(86) PCT No.: PCT/EP06/50757

§ 371 Date: May 20, 2008

(30) Foreign Application Priority Data
Feb. 9, 2005 (DE) 10 2005 005 982.1

(51) Int. Cl. B23B 51/06

(52) U.S. Cl. 408/59

(57) ABSTRACT

The present invention concerns a drill, in particular a deep hole drill, comprising a shaft (1) and a portion (2) which has flutes (6) and the length of which is more than three times the nominal diameter (D) and the front end of which is formed by a drill tip which is defined by main cutting edges (5) arranged in frontal relationship at the front end of the drill. In order to provide a drill having the above-mentioned features, which is capable in continuous operation of producing very deep drilled holes of more than 10 times to more than 20 times the nominal diameter and which in that respect is particularly economical in operation, it is proposed in accordance with the invention that the drill tip (3) and at least the region of the flutes (6) that adjoins the drill tip is coated with a hard material as far as a distance T from the tip of the drill, which at a maximum is three times the nominal diameter (D) while at least the flutes (6) are uncoated in the region which is spaced from the tip further than T, and wherein the drill core (4) in a region in the proximity of the drill tip is of a maximum diameter (K) which corresponds to at least 30%-55% of the nominal diameter, which narrows towards a region of the flute portion (2), that is closer towards the shaft (1), to a minimum diameter (k) of at most 20% to 50% of the nominal diameter, wherein the difference in the maximum core diameter (K) in the region of the tip in relation to the minimum core diameter (k) in the region closer towards the shaft (1) is at least 5% of the nominal diameter.

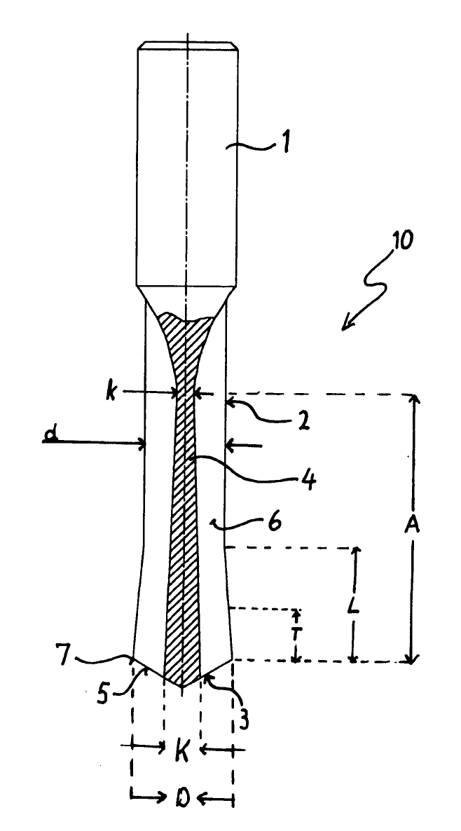

The invention concerns a drill, in particular a deep hole drill, comprising a shaft for clamping in a suitable chuck and a portion which has flutes and the length of which is more than three times the nominal diameter and the front end of which is formed by a drill tip which is defined by main cutting edges arranged in frontal relationship at the front end of the drill.

Corresponding drills have already long been known. The invention is in particular directed to what are known as deep hole drills in which the portion having flutes (referred to hereinafter as the ‘flute portion’) is at least six times and under some circumstances also more than ten times the nominal diameter of the drill. The features and principles of the present invention can however advantageously also be applied to drills in which the ratio of the length of the flute portion to the nominal diameter of the drill is below 8 and for that reason usually is not identified as a deep hole drill, even if the advantages of the measures according to the invention may not be compellingly required for use in relation to shorter drills of that kind.

A problem which can generally occur with drills but which occurs to an increased degree in particular in relation to deep hole drills is chip removal. That can represent a serious problem, particularly when dealing with materials which have a tendency to form long chips.

There are numerous approaches to resolving that problem. Some of the approaches are concerned with chip formation and chip shaping, that is to say the configuration of the main cutting edges and the region immediately adjoining same, where the chips are generated and shaped. Further approaches concern the size and the cross-sectional shape of the chip flutes and finally the pitch of the flutes which either extend straight, that is to say in parallel relationship with the axis or however extend in a spiral or helical configuration around the core of the drill can also be influenced in many different ways. In that respect the core of the drill is used to denote that part of the flute portion which is radially within the bottom of the flutes which is therefore not involved with the flutes.

Furthermore numerous attempts have also already been undertaken to coat corresponding drills or to produce them from the outset from a material which has advantageous wear properties but also advantageous frictional properties.

All those approaches were successful to a limited degree. Nonetheless particularly deep holes whose depth is more than 10 times and in particular more than 15 times the diameter often cannot be produced in one working operation, but the drill under some circumstances has to be withdrawn for the interim from the drilled hole in order firstly to remove the chips in order then to continue with drilling to the desired depth. Cooling lubricant supplied under high pressure through coolant bores also contributes to transporting the chips although it will be noted that large amounts of coolant lubricants of that kind are preferably avoided and so-called ‘minimal quantity lubrication’ with an oil/air mixture is in the meantime often preferred.

Therefore, in comparison with the known state of the art, the object of the present invention is to provide a drill having the features set forth in the opening part of this specification, which is capable in continuous operation of producing very deep holes of more than 10 times to more than 20 times the nominal diameter, and which in that case operates in a particularly economical fashion.

That object is attained in that the drill tip and at least the region of the flutes that adjoins the drill tip is coated with a hard material as far as a distance T from the tip of the drill, which at a maximum is three times the nominal diameter while at least the flutes are not coated with the hard material in the region which is spaced from the tip further than T, wherein the drill core in the region of the drill tip or in the proximity of the drill tip is of a maximum diameter which corresponds to at least 30%-55% of the nominal diameter of the drill, wherein said core diameter narrows towards a region of the flute portion, that is closer towards the shaft, to a minimum diameter of at most 20% to 50% of the nominal diameter, wherein the difference in the maximum core diameter in the region of the tip in relation to the minimum core diameter in the region closer towards the shaft is at least 5% of the nominal diameter.

A drill having that combination of features has proven to be surprisingly advantageous in terms of its chip formation and chip transport properties.

The coated tip which is known per se in particular for the purposes of enhancing the service life and improving the wear resistance of the drill evidently also contributes to advantageous chip formation.

In addition, by virtue of the large core diameter in the region of the tip, relatively little space is available for the chips at the beginning of the flutes, and that further compels them to be rolled in to a greater extent. In that respect nonetheless the flute is protected from severe wear as it is still coated in the region of the tip and also in the adjoining region.

At the same time the core diameter decreases from the tip to a region which is closer to the shaft so that the flutes become correspondingly deeper and can be of a larger cross-section. That facilitates chip transport through the flutes, in particular in consideration of the fact that chip transport is admittedly predominantly effected by cooling lubricant or compressed air but to a certain extent by the chips which are freshly generated at the drill tip and which are pushed along afterwards.

Preferably the flutes extend in a helical configuration, which further facilitates chip transport as the chips then partially rub against the wall of the hole and at the same time are entrained by the bottom or the wall of the flute, which as a result generates a force component acting on the chips, which is directed towards the shaft.

In particular for that purpose the pitch of the flutes or the pitch of the secondary cutting edges which adjoin the flutes, at the outer periphery of the drill, can be relatively small, that is to say it can include with the axis a relatively large angle of at least 20° and preferably at least 30°.

It has also proven to be particularly desirable if the coating in the interior of the flutes is restricted to a maximum of three times the drill diameter, as measured from the tip. The hard material coating generally has a greater coefficient of friction for the chips than the ground structure of the flutes of the uncoated drill. For that reason, it is desirable for chip transport if the greatest part of the length of the flutes involves a lower level of friction, the flutes therefore remain uncoated. The flutes can optionally also be polished.

The outside surfaces of the lands, in particular the round bevels, could also be coated with a hard material over the entire length of the flute portion. On the other hand however it is also not compellingly necessary for the lands or round bevels to be coated at all at their outside, but desirably the round bevels are also coated in the front region adjoining the tip, being the region where the inside surfaces of the flutes are also coated.

From manufacturing points of view, it is desirable if flutes and lands overall are coated over the same axial length. That resists wear of the round bevels in the region adjoining the tip.

In a preferred embodiment of the invention the outside diameter of the drill also narrows, beginning from a maximum diameter at the drill tip, more precisely at the transition of the drill tip to the flute portion, in the direction of the shaft, but to a lesser degree than the core. In that respect, in specific terms a preferred variant is one in which the taper of the outside diameter is between 1 μm and 8 μm per mm of distance from the drill tip or from the point of maximum diameter. That diametral tapering, as viewed from the tip, takes place over an axial length of a maximum of 8 times and preferably a maximum of 5 times and a minimum of twice the nominal diameter of the drill and then, in the remaining region to the clamping end, the outside diameter of the drill remains constant. Depending on the respective degree of taper and in dependence on the nominal diameter, the drill, for example with diameters above 2 mm in the flute portion adjoining the shaft, is of a diameter which is at least 4 μm and for example up to about 1 mm less than in the region of the drill tip. That reduces the friction of the drill or the round bevels against the wall of the drilled hole, without the danger arising that chips penetrate into the intermediate spaces between the outside diameter of the drill (defined by the round bevels) and the wall of the drilled hole. That is of particular importance in regard to the core tapering and the relatively great length of a deep hole drill as, with a high level of friction, in particular in the front portion of the drill, it is precisely the region involving the greatest core taper that would also become most loaded.

In the particularly preferred embodiment of the invention the maximum core diameter in the region of the tip of the drill or in the proximity thereof is at least 35% and at most 50% of the nominal diameter of the drill. It is further preferred if the difference between the maximum core diameter at the tip of the drill and the minimum core diameter further rearwardly in the proximity of the clamping portion is at most 20% of the nominal diameter. In that respect preferred differences between the minimum and maximum core diameter are of the order of magnitude of 5 to 12% of the nominal diameter, preferably between 6 and 10%.

Furthermore, in the preferred embodiment the dimension T over which the flutes and optionally also the outside surfaces of the lands, starting from the tip, are coated with a hard material, is about 0.5 to 2.5 times and particularly preferably between 1 and 1.5 times the nominal diameter of the drill. In that respect the distance T is measured from the axially rearward end of the drill tip, that is to say from the position at which the drill is of its maximum diameter or nominal diameter which is determined by the radially outer corners of the main cutting edges at the tip of the drill.

The length of the flute portion (=total length of the drill less the length of the shaft) is at least 8 times and preferably at least 10 times and particularly preferably more than 15 times the nominal diameter. That dimension respectively determines the drilled hole depth which can be achieved at a maximum with the drill in one drilling pass and which must always be somewhat less than the length of the flute portion so that the chips can still be conveyed out of the drilled hole, as far as the maximum drilled hole depth. It is at the latest from a value of 20 for the ratio of the length of the flute portion to the nominal diameter of the drill, that the advantages of the drill according to the invention become clearly apparent in terms of chip conveying, stability and productivity.

Furthermore in its preferred embodiment the drill according to the invention also has passages for the feed of a coolant.

Those passages firstly extend through the clamping portion of the shaft and then through the lands of the drill, which, with relatively great drill lengths in comparison with diameter, requires a precise arrangement for the passages and an ingenious and careful mode of manufacture.

Further advantages, features and possible uses of the present invention will be apparent from the description hereinafter of a preferred embodiment and the accompanying FIGURE. The single FIGURE shows a side view, partly in diagrammatic section, of a drill according to the invention in which however the diameter in relation to the drill length is greatly enlarged and wherein lands and the flutes are reproduced only by the outline of the round bevels, which corresponds to a cylinder in the upper portion and to a cone further down towards the tip.

The drill which is generally identified by reference 10 comprises a shaft 1, a flute portion 2 adjoining same and a drill tip 3 which defines the front face of the flute portion. The shaft 1 is shown in a side view while the greatest part of the flute portion is shown in axial longitudinal section (although without reproducing the helical configuration of the flutes) in which the inner core region 4 is shown by hatching. The drill tip 3 has generally two main cutting edges 5 which extend at an angle of between 60 and 70° relative to the axis of the drill from the centre or a position in the proximity of the centre outwardly and which by virtue of their outer ends define the maximum outside diameter D of the drill.

As will be seen, the core diameter of the drill continuously decreases starting from a maximum value K at the tip 3 of the drill to a minimum value k of the drill which is further rearwardly on the flute portion 2 closer towards the shaft 1 in order then to increase again at the end of the flute portion 2 and towards the shaft portion 1 until finally reaching the full diameter of the shaft 1 where the individual flutes 6 end. The depth of the flutes accordingly increases starting from the tip 3 of the drill towards the shaft. The outside diameter of the drill also decreases starting from the value D at the outer cutting corners 7 in the direction of the shaft 2, more specifically over a length L which is between twice and 8 times the nominal diameter D. It was noted that all axial dimensions in the drawings such as for example the dimension A or L and the dimension T, appear to be markedly shortened in comparison with the actual conditions, with respect to the diameter D. In actual fact the dimension T which identifies the length of the coating on the flutes is in the region of between 0.5 times and 3 times the drill diameter, preferably in the region of 1 to 1.5 times the drill diameter, in which respect moreover the entire tip 3 is also coated with a hard material.

The axial length A over which the core tapering occurs approximately corresponds to the maximum hole depth for which the drill is intended and is therefore approximately 10 to 20 times the drill diameter D or even thereabove. Maximum relationships in respect of length to diameter of the order of magnitude of over 40 have already been implemented in practice by the applicants in tests. In that respect a ratio of more than 20 is particularly preferred.

Furthermore it is also possible for the land width to be made continuously narrower from the drill tip towards the clamping end. That arrangement means that the flute cross-section can be enlarged once again, which further facilitates chip transport. The land width can also be kept relatively small from the outset.

In such an embodiment the cross-sectional shape of the flutes 6 corresponds to what is referred to as the ‘UFL’ cross-section as is defined in German patent application DE 196 27 436, and is thereby designed for optimum chip transport.

In addition the flutes can be polished, possibly also in the front portion which is coated with hard material.

The tapers both of the core and also of the outside diameter from their respective maximum to minimum values are preferably effected continuously and in a longitudinal section or with an outline as is shown in the FIGURE along a straight line, but in that respect other configurations in respect of the cross-sectional or outside diameter tapering would also be readily possible. The tapers could possibly also take place in a plurality of stages.

For the purposes of the original disclosure it is pointed out that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. A comprehensive explicit representation of all conceivable combinations of features is dispensed with here only for the sake of brevity and readability of the description.

1. A drill comprising a shaft and a portion which has flutes and a length of which is more than three times the nominal diameter (D) and a front end of which is formed by a drill tip which is defined by main cutting edges arranged in frontal relationship at the front end of the drill, wherein the drill tip and at least a region of the flutes that adjoins the drill tip is coated with a hard material as far as a distance T from a tip of the drill, which at a maximum is three times the nominal diameter (D) while at least the flutes are uncoated in a region which is spaced from the tip further than T, and wherein a drill core in a region in the proximity of the drill tip is of a maximum diameter (K) which corresponds to at least 30%-55% of the nominal diameter, which narrows towards a region of the flute portion, that is closer towards the shaft, to a minimum diameter (k) of at most 20% to 50% of the nominal diameter, wherein the difference in the maximum core diameter (K) in the region of the tip in relation to the minimum core diameter (k) in the region closer towards the shaft is at least 5% of the nominal diameter.

2. A drill according to claim 1 wherein that the maximum core diameter (K) is at least 35% and at most 50% of the nominal diameter (D).

3. A drill according to claim 1 wherein the difference (K-k) between maximum and minimum core diameter is at most 20% or the nominal diameter (D).

4. A drill according to claim 1 wherein the difference between maximum and minimum core diameter is between 5% and 12%.

5. A drill according to claim 1 wherein the distance T is between 0.5 and 2.5 times the nominal diameter.

6. A drill according to claim 1 wherein an outside diameter of the drill narrows from a maximum diameter of the drill at the transition from the tip to the secondary cutting edges rearwardly by an amount of 1 to 8 μm per mm in the axial direction as far as a distance L from the tip which is between 3 times and 10 times, the nominal diameter, and in other respects as far as the clamping portion is of a substantially constant minimum outside diameter value (d).

7. A drill according to claim 6 wherein the axial length of the flute portion is at least 20 times the nominal diameter (D).

8. A drill according to one claim 1 including cooling passages for passing a cooling lubricant or an air/oil mixture.

9. a drill according to claim 4, wherein the difference between maximum and minimum core diameter is between 6% and 10%.

10. A drill according to claim 5, wherein the distance T is between 1 and 1.5 times the nominal diameter.

11. A drill according to claim 6, wherein the distance L from the tip is between 4 times and 8 times the nominal diameter.

12. A drill according to claim 1 wherein the drill is a deep hole drill.
